(19) United States
(12) Patent Application Publication
(10) Pub. No.: US 2014/0181839 A1
(43) Pub. Date: Jun. 26, 2014

(54) CAPACITY-BASED MULTI-TASK SCHEDULING METHOD, APPARATUS AND SYSTEM

(71) Applicant: TENCENT TECHNOLOGY (SHENZHEN) COMPANY LIMITED, Shenzhen (CN)

(72) Inventors: Zhao XU, Guangdong (CN); Yanrong ZHAO, Guangdong (CN); Wei GUO, Guangdong (CN); Jun LI, Guangdong (CN); Wei ZHAO, Guangdong (CN); Shubin ZHANG, Guangdong (CN); Kungan HONG, Guangdong (CN)

(73) Assignee: TENCENT TECHNOLOGY (SHENZHEN) COMPANY LIMITED, Shenzhen (CN)

(21) Appl. No.: 14/189,518

(22) Filed: Feb. 25, 2014

Related U.S. Application Data
(63) Continuation of application No. PCT/CN2013/071087, filed on Jan. 29, 2013.

(30) Foreign Application Priority Data
Feb. 9, 2012 (CN) 201210028768.0

(51) Int. Cl. G06F 9/50

(52) U.S. Cl. CPC G06F 9/5088
USPC 718/107

(57) ABSTRACT

The present disclosure is applied to the technical field of data processing, and provided are a capacity-based multi-task scheduling method, apparatus and system. The method comprises: a scheduling node receiving a request for acquiring a task sent by a task executing node, the request carrying with a current load value and an available memory space of the task executing node; and the scheduling node deciding whether the current load value is less than a threshold, and carrying out task scheduling for the task executing node according to the available memory space of the task executing node if the current load value is less than the threshold. The present disclosure can effectively avoid the problems of overload, load, in sufficient memory, etc. of the task execution node, and increase the resource utilization rate of the task execution node and the task scheduling and executing efficiency.

### CROSS-REFERENCE TO RELATED APPLICATIONS

This application is a U.S. continuation application under 35 U.S.C. §111(a) claiming priority under 35 U.S.C. §§120 and 365(c) to International Application PCT/CN2013/071087 filed on Jan. 29, 2013, which claims the priority benefit of Chinese Patent Application No. 201210028768.0 filed on Feb. 9, 2012, the contents of which are incorporated by reference herein in their entirety for all intended purposes.

### TECHNICAL FIELD

The present disclosure relates to technical field of task scheduling, and in particular relates to a capacity-based multi-task scheduling method, apparatus and system.

### BACKGROUND

A reducing of a map (MapReduce) is a distributed parallel programming mode or a universal architecture for processing a large scale data set. A function of a distributed data processing is implemented by defining a corresponding map (Map) and reduce (Reduce) function.

FIG. 1 is a schematic diagram of the conventional task scheduling system based on a MapReduce architecture. As shown in FIG. 1, in the conventional task scheduling system based on the MapReduce architecture, there includes a scheduling node (JobTracker) and several task executing node (TaskTracker), the network architecture is as shown in FIG. 1. Here, a client is for submitting a parallel processing task arranged by a user to a scheduling node, the scheduling node separates the task submitted by the client into a plurality of Map tasks having same processing function (but the input data may be different) and a plurality of Reduce tasks having same processing function (but the processed data may be different), and buffers the separated tasks into a memory. When the task executing node does not reach a upper limit of a task executing ability thereof, that is, the number of the task executed currently is lower than the number of executable tasks, the task executing node requests a task to the scheduling node, and the scheduling node assigns one task in the separated tasks to the task executing node.

In the prior arts, when the hardware configuration of the task executing node is relatively low and resources occupied by the task running thereon is relatively more, for example, the task running occupies much system resources (CPU is overloaded and/or memory is insufficient or the like), if the task executing node has not reach a maximum task quota configured in advance, it still requests to run new task to the scheduling node. In this case, not only a situation that the new task can't be executed normally due to insufficient memory may occurs, but also the task being executed may be influenced, and it even causes the scheduling node to fail. Further, in case that the hardware configuration of the task executing node is higher or the resource occupied by the task running thereon is less, if the task executing node has reached the maximum task quota configured in advance, it no longer request to run new task to the scheduling node, so as to cause waste of the resource of the task executing node.

In summary, in the conventional task scheduling system based on a MapReduce architecture, the task executing node requests a task according to only configuration information configured in advance, and it may easily cause problems of overload of the task executing node, insufficient of the load and memory or the like, so as to influence efficiency of task scheduling and executing.

### SUMMARY

The present disclosure provides a multi-task scheduling method, apparatus, and system to reduce the problem of easily causing overload of the task executing node and insufficient of load and memory in the conventional task scheduling system based on a MapReduce architecture.

The present disclosure is implemented by a multi-task scheduling method comprising: receiving, a scheduling node, a request for acquiring a task sent by a task executing node, the request carrying with a current load value and an available memory space of the task executing node; and deciding, by the scheduling node, whether the current load value is less than a threshold, and carrying out task scheduling for the task executing node according to the available memory space of the task executing node if the current load value is less than the threshold.

There is provided a task scheduling apparatus comprising: a request information receiving unit configured to receive a request for acquiring a task sent by a task executing apparatus, the request carrying with a current load value and an available memory space of the task executing apparatus; a first deciding unit configure to decide whether the current load value is less than a threshold; a second deciding unit configure to decide whether there is a task to be assigned whose amount of memory requirement is less than or equal to the current available memory space of the task executing apparatus if the first deciding unit decides that the current load value is less than the threshold; and an assigning unit configure to assign the task whose amount of memory requirement is less than or equal to the current available memory space of the task executing apparatus to the task executing apparatus if the decision result of the second deciding unit is that there is a task to be assigned whose amount of memory requirement is less than or equal to the current available memory space of the task executing apparatus.

There is provided a task executing apparatus comprising: a request information sending unit configured to send a request for acquiring to a task to a task scheduling apparatus, the request carrying with a current load value and an available memory space of the task executing apparatus; and a task receiving unit configured to receive the task assigned by the task scheduling apparatus.

There is provided a multi-task scheduling system comprising the task scheduling apparatus provided by the present disclosure and at least one task executing apparatus provided by the present disclosure.

It can be seen from the above technical solutions that the present disclosure carries out the task scheduling according to the load value and the available memory space reported by the task executing node to assign a task to a task executing node having suitable load and sufficient memory, so as to reduce problems of overload and insufficient of the load and memory of the task executing node effectively, and increase the utilization ratio of the resource of the task executing node and efficiency of task scheduling and executing.

### BRIEF DESCRIPTION OF THE DRAWINGS

In order to explain technical solutions of the present disclosure more clear, the accompanying drawings needs to be used in the description of the embodiments or the prior arts are described simply. It is obvious for those skilled in the art that the accompanying drawings in the following description are only some embodiments of the present disclosure, and other accompanying drawings can be obtained according to these accompanying drawings without any inventive labor.

FIG. 1 is a schematic diagram of a conventional task scheduling system based on a MapReduce architecture;

FIG. 2 is a structural diagram of a constitution of a multi-task scheduling system provided by the first embodiment of the present disclosure;

FIG. 3 is a flow chart of an implementation of a multi-task scheduling method provided by the second embodiment of the present disclosure;

FIG. 4 is a structural diagram of a constitution of a task scheduling apparatus provided by the third embodiment of the present disclosure;

FIG. 5 is a structural diagram of a constitution of a task executing apparatus provided by the fourth embodiment of the present disclosure.

### DETAILED DESCRIPTION

In order to make the technical solutions and advantages of the present disclosure more clear, the present disclosure is further described detailed by referring to the accompanying drawings and in combination with the embodiments. It is understood that the specific embodiments described here is only for explaining the present disclosure but not for limiting the present disclosure.

In order to explain the technical solution of the present disclosure, it is explained by the specific embodiments.

### The First Embodiment

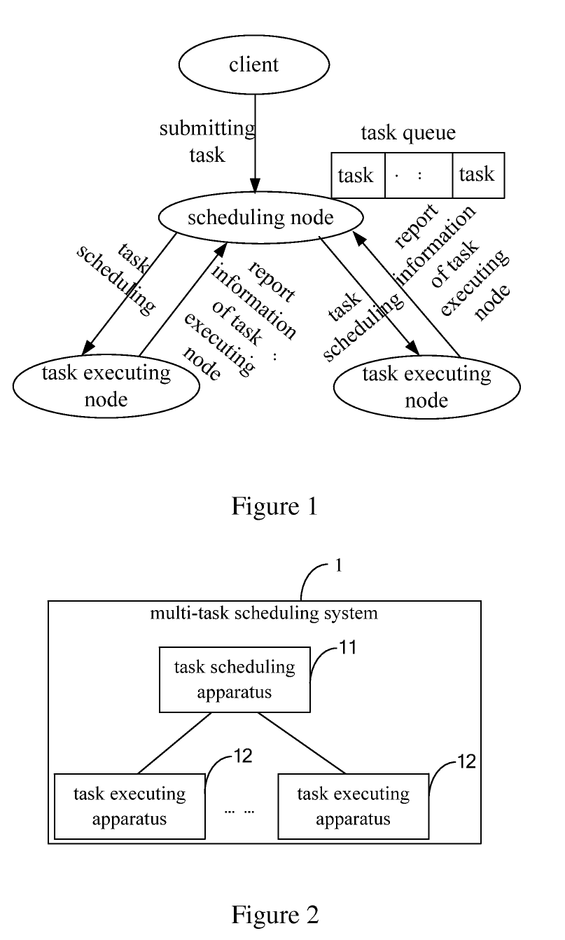

FIG. 2 is a structural diagram of a constitution of a multi-task scheduling system provided by the first embodiment of the present disclosure, which illustrates the constitutional structure of the multi-task scheduling system provided by the first embodiment of the present disclosure, and only illustrates parts related to the embodiments of the present disclosure for the convenience of explanation.

The multi-task scheduling system 1 comprises a task scheduling apparatus 11 and at least one task executing apparatus 12. The multi-task scheduling system is based on a MapReduce architecture.

The task scheduling apparatus 11 connects to the task executing apparatus 12 to communicate in wired or wireless manner, and is for receiving a request for acquiring a task and carrying with information such as a current load value, an available memory space or the like sent by the task executing apparatus 12, and carrying out task scheduling for the task executing apparatus 12 according to the carried information such as the current load value, the available memory space or the like.

The task executing apparatus 12 is for sending a request for acquiring a task and carrying with information such as the current load value, the available memory space or the like to the task scheduling apparatus 11, and receiving the task assigned by the task scheduling apparatus 11.

### The Second Embodiment

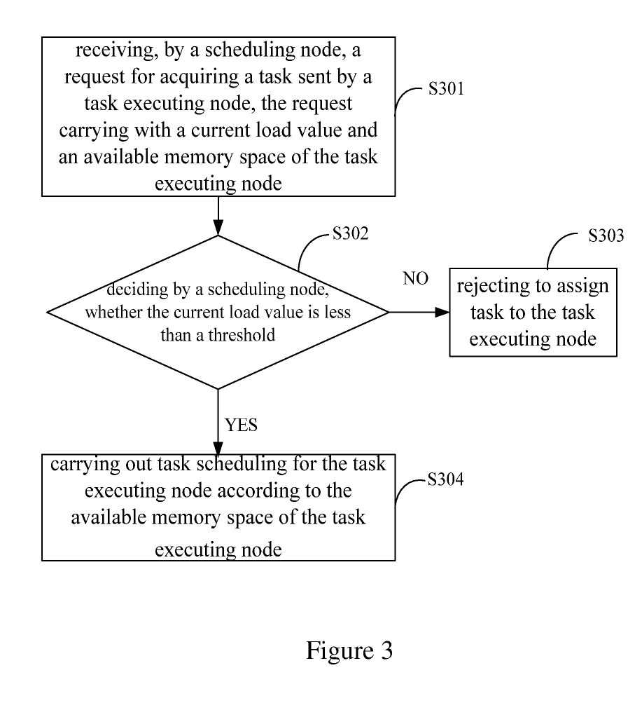

FIG. 3 is a flow chart of an implementation of a multi-task scheduling method provided by the second embodiment of the present disclosure, which illustrates a flow of implementation of the multi-task scheduling method provided by the second embodiment of the present disclosure. The procedure of the method is described detailed as follows.

In step S301, the task executing node sends a request for acquiring a task to the scheduling node, wherein the request carries a current load value and an available memory space of the task executing node therein.

In the present embodiment, when the task executing node triggers to send a heartbeat message, the request for acquiring a task is sent to the scheduling node by the heartbeat message, wherein the request carries the current load value and the available memory space of the task executing node or the like therein.

Here, the current load value of the task executing node refers to a current processing capability of the task executing node, for example, a usage ratio of the CPU of the task executing node or the like. The computing formula of the available memory space of the task executing node is:

M_{A}=M_{P}−M_{U}−M_{T}−M_{S}

Here, M_{A} is the available memory space, M_{P} is a practical memory space, M_{U} is a used memory space, M_{T} is a system preserved memory space of the task executing node, and M_{S} is a preserved memory space of the assigned task.

In step S302, the scheduling node decides whether the current load value is less than a threshold. If the decision result is “YES”, that is, if the current load value is less than a threshold, step S304 is executed, and if the decision result is “NO”, that is, if the current load value is greater than or equal to the threshold, step S303 is executed.

This threshold can be a preset threshold, or a dynamic threshold, which includes, but is not limited to a system average load magnitude.

It exemplifies that (but not limit to the example), when the current load value of the task executing node is reflected by the usage ratio of the CPU, it decides whether the current usage ratio of the CPU of the task executing node is less than a preset threshold (for example, 60%). If the current usage ratio of the CPU of the task executing node is less than the preset threshold, step S304 is executed, and otherwise, step S303 is executed.

In step S303, the task executing node is rejected to be assigned a task.

In the present embodiment, in order to avoid overload of the task executing node to influence executing efficiency of the task, the scheduling node rejects the request for acquiring a task of the task executing node whose current load value is greater than or equal to a threshold.

In step S304, the task executing node carries out the task scheduling according to the available memory space of the task executing node.

In the present embodiment, in order to avoid the amount of memory requirement of the newly assigned task being so large as to cause problem that the memory of the task executing node is insufficient to be executed normally, and influence the task being executed so that the scheduling node is fail or the like, the scheduling node of the present embodiment scans each task to be assigned in a task queue in order, to decide whether there is a task to be assigned whose amount of memory requirement is less than or equal to the available memory space of the task executing node currently. If there is a task to be assigned whose amount of memory requirement is less than or equal to the available memory space of the task executing node currently, the scheduling node assigns the task whose amount of memory requirement is less than or equal to the available memory space of the task executing node to the task executing node, and otherwise, the scheduling node rejects to assign task to the task executing node.

In the present embodiment, deciding whether there is the task to be assigned whose amount of memory requirement is less than or equal to the available memory space of the task executing node is specifically as follows: deciding whether the result of the practical memory space subtracting the used memory space subtracting the system preserved memory space of the task executing node subtracting the preserved memory space of the assigned task subtracting the memory space of the task which is prepared to be assigned but not send out yet is greater than or equal to zero, and if this result is greater than or equal to zero, it represents that the memory of the task executing node is sufficient, the scheduling node can send out the task; and otherwise, it represents the memory of the task executing node is insufficient, and the scheduling node rejects to send out task to the task executing node until the task executing node applies a task again.

In the embodiments of the present disclosure, the task executing node can request a task to the scheduling node according to configuration information configured in advance, but the request carries the current load value and the available memory space of the task executing node therein. The scheduling node decides whether to assign the task to the task executing node according to the current load value and the available memory space of the task executing node and select a suitable task to be assigned as assigning the task, thus, the problems of overload, insufficient of the load and memory of the task executing node can be avoided effectively, and the utilization ratio of the resource of the task executing node and the efficiency of the task scheduling and executing are increased.

### The Third Embodiment

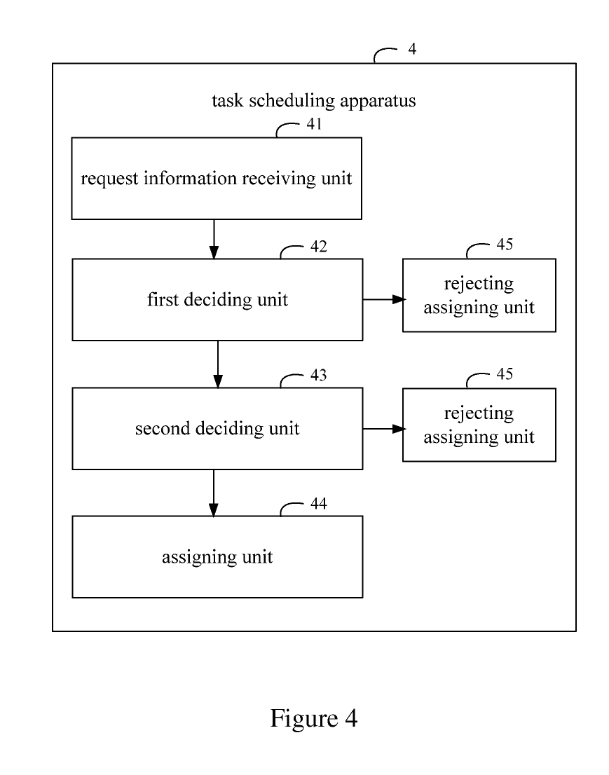

FIG. 4 is a structural diagram of a constitution of a task scheduling apparatus provided by the third embodiment of the present disclosure, which illustrates the constitutional structure of the task scheduling apparatus provided by the third embodiment of the present disclosure, and only illustrates parts related to the embodiments of the present disclosure for the convenience of explanation.

The task scheduling apparatus may be a software unit, a hardware unit or a unit combining software and hardware running in the multi-task scheduling system, and may be integrated into the multi-task scheduling system or running in application system of the multi-task scheduling system as an independent plug-in.

The task scheduling apparatus 4 comprises a request information receiving unit 41, a first deciding unit 42, a second deciding unit 43 and an assigning unit 44, the specific functions of which are as follows:

The request information receiving unit 41 is configured to receive a request for acquiring a task sent by the task executing apparatus, wherein the request carries a current load value and an available memory space of the task executing apparatus therein.

The first deciding unit 42 is configured to decide whether the current load value is less than a threshold.

The second deciding unit 43 is configured to decide whether there is a task to be assigned whose amount of memory requirement is less than or equal to the available memory space of the task executing apparatus when the decision result of the first deciding unit 42 is YES, i.e., the current load value is less than a threshold.

The assigning unit 44 is configured to assign the task whose amount of memory requirement is less than or equal to the current available memory space of the task executing apparatus to the task executing apparatus if the decision result of the second deciding unit 43 is YES, that is, there is a task to be assigned whose amount of memory requirement is less than or equal to the available memory space of the task executing apparatus.

Further, in order to avoid problems of overload or insufficient memory of the task executing node and increase the utilization ratio of the resource of the task executing node and efficiency of task scheduling and executing, the task scheduling apparatus 4 further comprises a rejecting assigning unit 45 configured to reject to assign task to the task executing apparatus when the current load value of the task executing apparatus is larger than or equal to a threshold or the amount of memory requirement of all of the task to be assigned are larger than the available memory space of the task executing apparatus.

The task scheduling apparatus provided by the present embodiment can be applied in the above-mentioned multi-task scheduling method, the detail of which can be referred to the relative description of the second embodiment of the multi-task scheduling method and is no longer described herein.

### The Fourth Embodiment

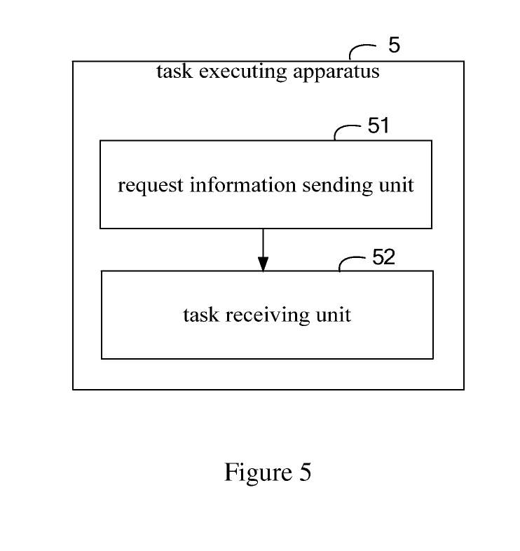

FIG. 5 is a structural diagram of a constitution of a task executing apparatus provided by the fourth embodiment of the present disclosure, which illustrates the constitutional structure of the task executing apparatus provided by the fourth embodiment of the present disclosure, and only illustrates parts related to the embodiments of the present disclosure for the convenience of explanation.

The task executing apparatus may be a software unit, a hardware unit or a unit combining software and hardware running in the multi-task scheduling system, and may be integrated into the multi-task scheduling system or running in application system of the multi-task scheduling system as an independent plug-in.

The task executing apparatus 5 comprises a request information sending unit 51 and a task receiving unit 52, the specific functions of which are as follows:

The request information sending unit 51 is configured to send a request for acquiring a task to the task scheduling apparatus, the request carries a current load value and an available memory space of the task executing apparatus therein.

The task receiving unit 52 is configured to receive the task assigned by the task scheduling apparatus.

In the present embodiment, the computing formula of the current available memory space of the task executing apparatus is:

M_{A}=M_{P}−M_{U}−M_{T}−M_{S}

Here, M_{A} is the available memory space, M_{P} is a practical memory space, M_{U} is a used memory space, M_{T} is a system preserved memory space of the task executing node, and M_{S} is a preserved memory space of the assigned task.

The task executing apparatus provided by the present embodiment can be applied in the above-mentioned multi-task scheduling method, the detail of which can be referred to the relative description of the second embodiment of the multi-task scheduling method and is no longer described herein.

Those skilled in the art can understand that the respective units included in the apparatus of the third embodiment and the fourth embodiment are divided according to functional logic, and not restricted to the above division as long as corresponding functions can be implemented. Further, the specific names of the respective functional units are only for distinguishing from each other, and are not for limiting the range sought for protection by the present disclosure.

In summary, the capacity-based task scheduling algorithm of the present disclosure takes the maximum value set for the memory of the task as basis of assigning the task and records condition of load, schedule of task execution and memory occupancy of corresponding task of the respective nodes. The status information collected by the nodes is reported to task scheduler controlling the nodes as asking for the task, wherein the task scheduler selects a task which satisfies the requirement in the queue of the current executable task to send out to the computing node according to the status of the computing node, so as to avoid problems of overload and insufficient of the load and memory of the task executing node or the like effectively, and increase the utilization ratio of the resource of the task executing node and efficiency of task scheduling and executing. Implementation of the present disclosure is simple and practicability thereof is strong.

Those skilled in the art can understand that, all or a part of steps for implementing the method of the above-described embodiment can be completed by instructing the related hardware through the program, which can be stored in a computer readable storage medium including ROM/RAM, disk, optical disk or the like.

The above mentioned is only preferred embodiment of the present disclosure and did not limit the present disclosure to any of the modification, and equivalent replacement and improvement or the like within the spirit and principle of the present disclosure should be included in the range sought for protection by the present disclosure.

1. A multi-task scheduling method, comprising:
receiving, by a scheduling node, a request for acquiring a task sent by a task executing node, the request carrying with a current load value and an available memory space of the task executing node; and
deciding, by the scheduling node, whether the current load value is less than a threshold, and carrying out task scheduling for the task executing node according to the available memory space of the task executing node if the current load value is less than the threshold.

2. The method according to claim 1, wherein the scheduling node carrying out task scheduling for the task executing node according to the available memory space of the task executing node comprises:
deciding, by the scheduling node, whether there is a task to be assigned whose amount of memory requirement is less than or equal to the available memory space of the task executing node in the scheduling nodes;
assigning, by the scheduling node, the task whose amount of memory requirement is less than or equal to the available memory space of the task executing node to the task executing node if so; and
rejecting, by the scheduling node, to assign task to the task executing node if not.

3. The method according to claim 1, further comprising:
rejecting, by the scheduling node, to assign task to the task executing node when it decides that the current load value of the task executing node is larger than or equal to a threshold.

4. The method according to claim 1, wherein, a computing formula of the available memory space of the task executing node is:
M_{A}=M_{P}−M_{U}−M_{T}−M_{S}
M_{A} is the available memory space, M_{P} is a practical memory space, M_{U} is a used memory space, M_{T} is a system preserved memory space of the task executing node, and M_{S} is a preserved memory space of the assigned task.

5. A task scheduling apparatus, comprising:
a request information receiving unit configured to receive a request for acquiring a task sent by a task executing apparatus, the request carrying with a current load value and an available memory space of the task executing apparatus;
a first deciding unit configure to decide whether the current load value is less than a threshold;
a second deciding unit configure to decide whether there is a task to be assigned whose amount of memory requirement is less than or equal to the current available memory space of the task executing apparatus if the first deciding unit decides that the current load value is less than the threshold; and
an assigning unit configure to assign the task whose amount of memory requirement is less than or equal to the current available memory space of the task executing apparatus to the task executing apparatus if the decision result of the second deciding unit is that there is a task to be assigned whose amount of memory requirement is less than or equal to the current available memory space of the task executing apparatus.

6. The apparatus according to claim 5, further comprising:
a rejecting assigning unit configured to reject to assign task to the task executing apparatus when the current load value of the task executing apparatus is larger than or equal to a threshold or amount of memory requirement of all of the task to be assigned are larger than the available memory space of the task executing apparatus.

7. A task executing apparatus, comprising:
a request information sending unit configured to send a request for acquiring to a task to a task scheduling apparatus, the request carrying with a current load value and an available memory space of the task executing apparatus; and
a task receiving unit configured to receive the task assigned by the task scheduling apparatus.

8. The apparatus according to claim 7, wherein, a computing formula of the available memory space of the task executing apparatus is:
M_{A}=M_{P}−M_{U}−M_{T}−M_{S}
M_{A} is the available memory space, M_{P} is a practical memory space, M_{U} is a used memory space, M_{T} is a system preserved memory space of the task executing node, and M_{S} is a preserved memory space of the assigned task.
